(19) United States
(12) Patent Application Publication
(10) Pub. No.: US 2015/0215514 A1
(43) Pub. Date: Jul. 30, 2015

(54) DEVICE FOR WIRELESSLY CONTROLLING A CAMERA

(71) Applicant: VOXX INTERNATIONAL CORPORATION, Hauppauge, NY (US)

(72) Inventors: Alfred Barabas, LaHabra, CA (US); Laszlo Barabas, Palos Verdes Penninsula, CA (US); Thomas Malone, Miller Place, NY (US); James Tranchina, Dix Hills, NY (US)

(21) Appl. No.: 14/603,594

(22) Filed: Jan. 23, 2015

Related U.S. Application Data
(60) Provisional application No. 61/931,287, filed on Jan. 24, 2014.

(51) Int. Cl. H04N 5/232; H04N 1/00; H04W 4/00

(52) U.S. Cl. CPC H04N 5/23203; H04W 4/008; H04N 1/00307; H04N 5/23296

(57) ABSTRACT

A system for wirelessly controlling a camera including: a camera control device including a display and a transceiver, and a smartphone/tablet including a camera module, a display disposed on a first side of the smartphone/tablet, and a transceiver, the camera module including a first camera disposed on the first side of the smartphone/tablet and a second camera disposed on a second side of the smartphone/tablet, wherein when an image shown on the display of the smartphone/tablet is shown on the display of the camera control device, the camera control device is configured to control the smartphone/tablet to take a picture of the image shown on the display of the smartphone/tablet.

### CROSS-REFERENCE TO RELATED APPLICATION

This application claims priority under 35 U.S.C. §120 to U.S. provisional application No. 61/931,287, filed Jan. 24, 2014, the disclosure of which is incorporated by reference herein in its entirety.

### TECHNICAL FIELD

The present invention relates to smartphone/tablet accessories, and more particularly, to a device for controlling a camera employed by a smartphone/tablet.

### DISCUSSION OF THE RELATED ART

While taking self photos, iPhone and Android phone users are forced to choose between a low-resolution front facing camera if they want to see themselves in a viewfinder, or a high-resolution rear facing camera in which they will have to take a photo of themselves without looking at the viewfinder.

### SUMMARY OF THE INVENTION

According to an exemplary embodiment of the present invention, there is provided a system for wirelessly controlling a camera comprising: a camera control device including a display and a transceiver; and a smartphone/tablet including a camera module, a display disposed on a first side of the smartphone/tablet, and a transceiver, the camera module including a first camera disposed on the first side of the smartphone/tablet and a second camera disposed on a second side of the smartphone/tablet, wherein when an image shown on the display of the smartphone/tablet is shown on the display of the camera control device, the camera control device is configured to control the smartphone/tablet to take a picture of the image shown on the display of the smartphone/tablet.

The image shown on the display of the smartphone/tablet is wirelessly transmitted to the camera control device.

The transceiver of the camera control device is a Bluetooth transceiver and the transceiver of the smartphone/tablet is a Bluetooth transceiver.

The first camera has a lower resolution than the second camera.

The first camera is a front facing camera and the second camera is a rear facing camera.

The image shown on the display of the smartphone/tablet is shown on the display of the camera control device upon activation of a software application at the smartphone/tablet.

The software application is activated when a user touches an icon corresponding to the software application on the display of the smartphone/tablet.

When the image shown on the display of the smartphone/tablet is shown on the display of the camera control device, the camera control device is configured to control the smartphone/tablet to take a video of the image shown on the display of the smartphone/tablet.

When the image shown on the display of the smartphone/tablet is shown on the display of the camera control device, the camera control device is configured to control the camera module of the smartphone/tablet to zoom-in or zoom-out.

A user does not hold the smartphone/tablet when the picture is taken.

The picture is taken by the second camera.

According to an exemplary embodiment of the present invention, there is provided a system for wirelessly controlling a camera comprising: a camera control device including a transmitter and an input; and a smartphone/tablet including a camera module, a display disposed on a first side of the smartphone/tablet, and a receiver, the camera module including a first camera disposed on the first side of the smartphone/tablet and a second camera disposed on a second side of the smartphone/tablet, wherein when an image is shown on the display of the smartphone/tablet, the input of the camera control device is configured to control the smartphone/tablet to take a picture of the image.

The input includes a button.

The input is responsive to a voice command.

The camera control device is a handheld remote.

A user does not hold the smartphone/tablet when the picture is taken.

According to an exemplary embodiment of the present invention, there is provided a system for wirelessly controlling a camera comprising: a camera control device including a display and a transceiver; and an electronic device including a camera module and a transceiver, wherein when an image viewed by the electronic device is shown on the display of the camera control device, the camera control device is configured to control the electronic device to take a picture of the image.

The electronic device is wirelessly controlled by the camera control device.

A user does not hold the electronic device when the picture is taken.

### BRIEF DESCRIPTION OF THE DRAWINGS

FIG. 1 illustrates a system including a device for wirelessly controlling a camera in accordance with an exemplary embodiment of the present invention;

FIG. 2 illustrates viewfinder according to an exemplary embodiment of the present invention; and

FIG. 3 illustrates a method of operating a device for wirelessly controlling a camera in accordance with an exemplary embodiment of the present invention.

### DETAILED DESCRIPTION OF EXEMPLARY EMBODIMENTS

In accordance with an exemplary embodiment of the present invention, there is provided a device for wirelessly controlling a camera. This device is capable of wirelessly controlling a smartphone/tablet so that pictures can be taken using a high-resolution rear facing camera of the smartphone/tablet while seeing what is shown in a viewfinder of the smartphone/tablet, for example. In the following embodiments, a camera of a smartphone/tablet is described as being controlled; however, a wireless remote camera may be controlled in the same or similar manner.

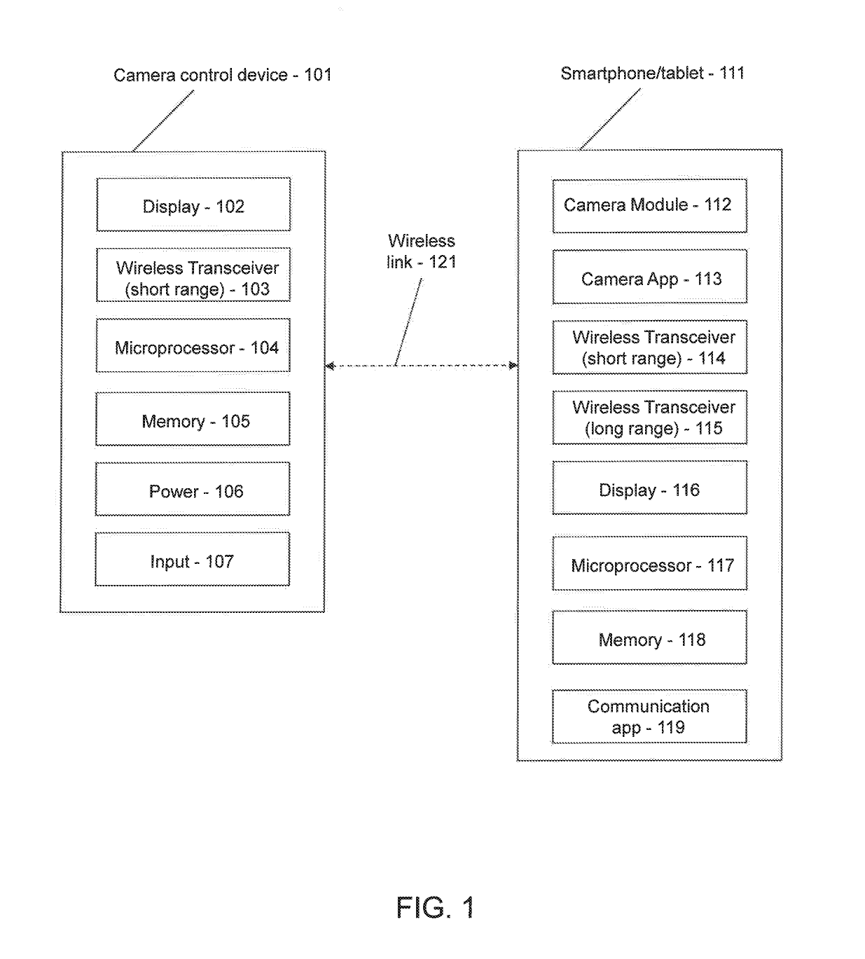

FIG. 1 illustrates a system including a device for wirelessly controlling a camera in accordance with an exemplary embodiment of the present invention. For example, as shown in FIG. 1 there is provided a camera control device 101 and a smartphone/tablet 111. The camera control device 101 and the smartphone/tablet 111 may communicate via a wireless link 121.

The camera control device 101 includes a display 102, a short-range wireless transceiver 103, a microprocessor 104, a memory 105, a power supply 106 and an input 107. The camera control device 101 may be a hand-held remote control. For example, the physical look of the camera control device 101 may resemble a keychain picture frame. The picture frame may be a 1.5 inch display. The size of the display is not limited thereto. The camera control device 101 may be a wearable technology such as a smartwatch, or any other computing device capable of controlling the smartphone/tablet 111.

As will be discussed later, the camera control device 101 will be able to control the smartphone/tablet 111 when an appropriate app is downloaded to the smartphone/tablet 111. In addition, the camera control device 101 may be a native or core part of the operating system of the smartphone/tablet 111, and thus, app download will not be required for control. In other words, the smartwatch is already part of the smartphone/tablet 111.

The display 102 may be any of a variety of electronic visual displays such as a liquid crystal display or an organic light emitting diode display, for example. The display may have a 4:3 aspect ratio to match an image captured on the smartphone/tablet 111, and may have at least 160×120 pixel resolution with 8 or 16 bit color depth or higher. The pixel resolution and color depth is not limited thereto. The display 102 may be a touch screen display.

The short-range wireless transceiver 103 may be any type of transceiver having sufficient throughput to receive near real-time image data from the smartphone/tablet 11. For example, the short-range wireless transceiver 103 may be a Bluetooth transceiver having a data transfer rate of 721 Kbps. This bandwidth is capable of transmitting/receiving voice, data, video and still images to/from the smartphone/tablet 111. Higher or lower data transfer rates may also be used. As another example, the short-range wireless transceiver 103 may be implemented with WiFi.

The microprocessor 104 controls a general operation of the camera control device 101. The memory 105 may include a volatile memory such as a random access memory (RAM) and a nonvolatile memory such as flash memory. The RAM may be used as a working memory of the microprocessor 104. The nonvolatile memory may be used to store images or video captured by a camera of the smartphone/tablet 111.

The power supply 106 may be an on board battery that can be recharged via a physical port in the camera control device 101 such as a universal serial bus (USB) receptacle, or via a wireless charger. The input 107 may be a button or switch included on the camera control device 101. The input 107 can also be a voice activated device. The input 107 may be used to activate the camera control device 101 or control the camera of the smartphone/tablet 111. The touch screen display 102 may also serve as an input.

The smartphone/tablet 111 includes a camera module 112, a camera app 113, a short-range wireless transceiver 114, a long-range wireless transceiver 115, a display 116, a microprocessor 117, a memory 118 and a communication app 119. The smartphone may be any of a number of smartphones such as an iPhone or Android phone, for example. The tablet may be any of number of tablets such as an iPad or Android tablet, for example. The smartphone/tablet 111 is built on a mobile operating system such as iOS or Android, for example.

The camera module 112 includes a camera on the front side of the smartphone/tablet 111 and a camera on the rear side of smartphone/tablet 111. The rear side camera may have a higher resolution than the front side camera. For example, the rear side camera may have an 8 megapixel or higher resolution and the front side camera may have a 2 megapixel resolution. The rear camera includes a flash and the front camera does not. The camera module 112 may further enable full high definition (HD) recording via the front and rear cameras.

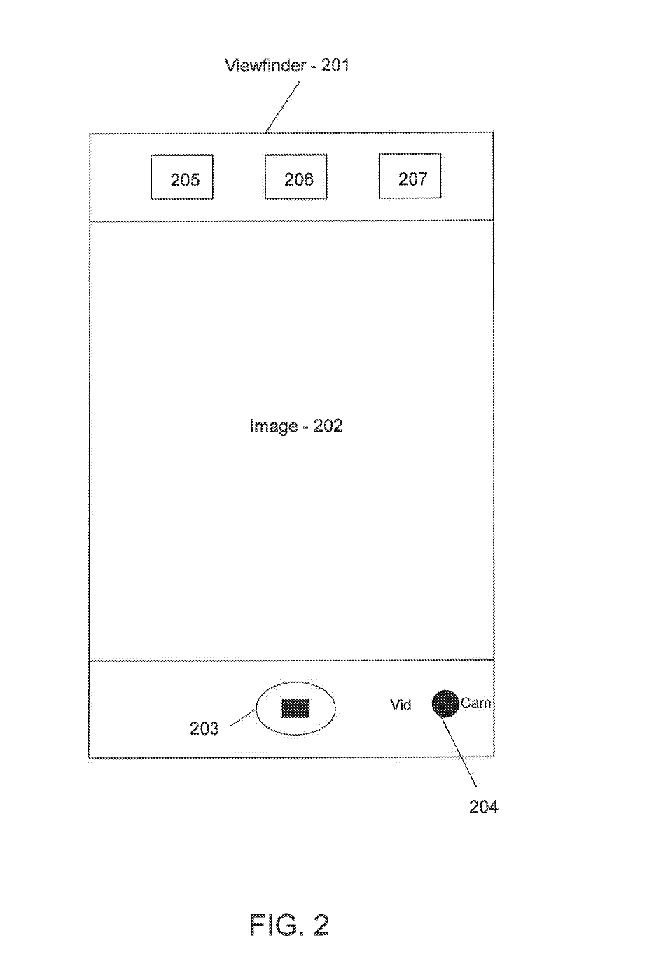

The camera app 113 is a software application that can be activated by touching a corresponding icon on the display 116. The camera app 113 and other apps of the smartphone/tablet 111 may also be activated with a voice command. When activated, the display 116 of the smartphone/tablet 111 shows a current image seen by either the front or rear cameras. This may be referred to as a viewfinder. A viewfinder 201 according to an exemplary embodiment of the present invention is shown in FIG. 2.

As shown in FIG. 2, surrounding an image 202 on the viewfinder 201 may be certain icons for operating the cameras. For example, below the image 202 there may be an icon used for taking a photo 203 and an icon for switching from camera mode to video mode 204. Above the image 202 may be icons for changing shooting modes 205, turning on/off the flash 206 or switching from the front camera to the rear camera 207, for example. These configurations are merely exemplary and not limiting in any way. The camera app 113 may be stored in a nonvolatile memory of the memory 118.

The short-range wireless transceiver 114 employed by the smartphone/tablet 111 may be the same as that described above with reference to the camera control device 101. In any event, the short range wireless transceivers 103 and 114 are compatible such that they permit the camera control device 101 and smartphone/tablet 111 to communicate via the wireless link 121. The long range wireless transceiver 115 may be a radio frequency (RF) transceiver permitting internet access via a cellular provider, for example.

The smartphone/tablet 111 display 116 may have a higher resolution than that of the camera control device 101. For example, the display 116 may have a resolution of 1920×1080. The display 116 is a touch screen.

The microprocessor 117 controls a general operation of the smartphone/tablet 111. The memory 118 may include a volatile memory such as a RAM and a nonvolatile memory such as flash memory. The RAM may be used as a working memory of the microprocessor 117. The nonvolatile memory may be used to store images or video taken by the camera module 112.

The communication app 119 may be downloaded to the smartphone/tablet 111. The communication app 119 can also be part of the native or core operating system of the smartphone/tablet 111, and thus, not have to be downloaded. When activated, by touching the display 116 for example, the communication app 119 will enable the image 202 seen on the viewfinder 201 to be displayed on the display 102 of the camera control device 101. This image may be streamed in near real time fashion over the wireless link 121. The communication app 119 may further enable the entire contents of the viewfinder 201 to be displayed on the display 102 of the camera control device 101. For example, all or some of the icons 203-207 may be reproduced on the display 102 of the camera control device 101 to match the way they are shown on display 116 of the smartphone/tablet 111. The icons 203-207, however, do not have to match the way they are shown on the display 116 of the smartphone/tablet 111, and thus, may look different or be configured differently on the display 102 of the camera control device 111. When the communication app 119 is activated, a user of the camera control device 101 may control the camera module 112 of the smartphone/tablet 111 with the reproduced viewfinder 201 on the display 102 of the camera control device 101. For example, the user can turn on/off the flash of the camera module 112 of the smartphone/tablet 111 with the camera control device 101.

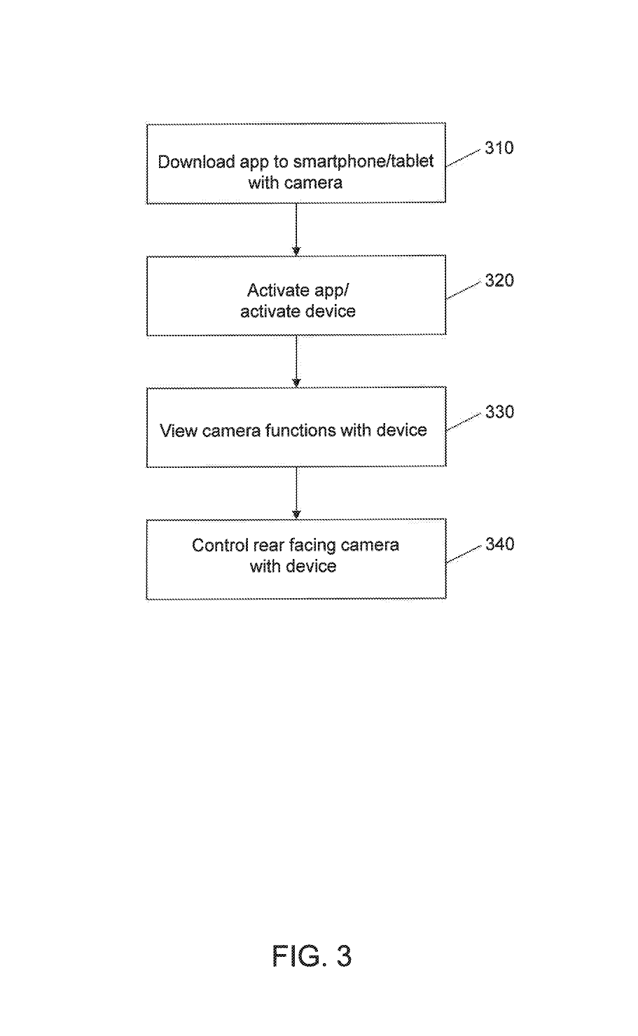

FIG. 3 illustrates a method of operating a device for wirelessly controlling a camera in accordance with an exemplary embodiment of the present invention. As shown in FIG. 3, a user of the smartphone/tablet 111 may download the communication app 119 over a wireless link from the internet (310). The user may then activate the communication app 119 by touching the display 116 of the smartphone/tablet 111 and activate the camera control device 101 with the input 107 (320).

At this time, when the camera app 113 of the smartphone/tablet 111 is activated, the image 202 currently seen on the viewfinder 201 is displayed on the display 102 of the camera control device 101 (330). Further, the icons 203-207 are displayed on the display 102 of the camera control device 101 (330). The user can then take a picture of himself with the high resolution rear side camera or control other camera functions with the reproduced viewfinder 201 (340).

For example, the user can position the smartphone/tablet 111 away from his body so that he is no longer touching it and, while in physical possession of the camera control device 101, position himself the way he wants to be photographed while looking at the reproduced viewfinder 201 on the display 102 of the camera control device 101. Once the user is satisfied with the way he looks, he can push the corresponding take photo icon 203 on the reproduced viewfinder 201 to capture his image. It is to be understood that physical possession of the camera control device 101 is not required and voice commands can instruct the camera control device 101 to make the smartphone/tablet 111 take a picture. The image taken can be displayed to the user for a predetermined time on the display 102 of the camera control device 101. The user can save the image to the memory 105 of the camera control device 101 or delete the image. The image could also be saved to the memory 118 of the smartphone/tablet 111.

The aforementioned process can be repeated a number of times. Further, the aforementioned process is not limited to just picture taking. For example, the user could frame a scene to be filmed by the smartphone/tablet 111, and activate the filming with the camera control device 101. The framing could be done with the smartphone/tablet 111 independent of the camera control device 101, or the framing could be done at the camera control device 101 by controlling zoom functions of the camera module 112, for example.

The computing platforms of the camera control device 101 and smartphone/tablet 111 include an operating system and micro-instruction code. The various processes and functions described herein may either be part of the micro-instruction code or part of the application program (or a combination thereof) which is executed via the operating system.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a RAM, a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article or manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical functions(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A system for wirelessly controlling a camera, comprising:
a camera control device including a display and a transceiver; and
a smartphone/tablet including a camera module, a display disposed on a first side of the smartphone/tablet, and a transceiver, the camera module including a first camera disposed on the first side of the smartphone/tablet and a second camera disposed on a second side of the smartphone/tablet,
wherein when an image shown on the display of the smartphone/tablet is shown on the display of the camera control device, the camera control device is configured to control the smartphone/tablet to take a picture of the image shown on the display of the smartphone/tablet.

2. The system of claim 1, wherein the image shown on the display of the smartphone/tablet is wirelessly transmitted to the camera control device.

3. The system of claim 1, wherein the transceiver of the camera control device is a Bluetooth transceiver and the transceiver of the smartphone/tablet is a Bluetooth transceiver.

4. The system of claim 1, wherein the first camera has a lower resolution than the second camera.

5. The system of claim 1, wherein the first camera is a front facing camera and the second camera is a rear facing camera.

6. The system of claim 1, wherein the image shown on the display of the smartphone/tablet is shown on the display of the camera control device upon activation of a software application at the smartphone/tablet.

7. The system of claim 6, wherein the software application is activated when a user touches an icon corresponding to the software application on the display of the smartphone/tablet.

8. The system of claim 1, wherein when the image shown on the display of the smartphone/tablet is shown on the display of the camera control device, the camera control device is configured to control the smartphone/tablet to take a video of the image shown on the display of the smartphone/tablet.

9. The system of claim 1, wherein when the image shown on the display of the smartphone/tablet is shown on the display of the camera control device, the camera control device is configured to control the camera module of the smartphone/tablet to zoom-in or zoom-out.

10. The system of claim 1, wherein a user does not hold the smartphone/tablet when the picture is taken.

11. The system of claim 1, wherein the picture is taken by the second camera.

12. A system for wirelessly controlling a camera, comprising:
a camera control device including a transmitter and an input; and
a smartphone/tablet including a camera module, a display disposed on a first side of the smartphone/tablet, and a receiver, the camera module including a first camera disposed on the first side of the smartphone/tablet and a second camera disposed on a second side of the smartphone/tablet,
wherein when an image is shown on the display of the smartphone/tablet, the input of the camera control device is configured to control the smartphone/tablet to take a picture of the image.

13. The system of claim 12, wherein the input includes a button.

14. The system of claim 12, wherein the input is responsive to a voice command.

15. The system of claim 12, wherein the camera control device is a handheld remote.

16. The system of claim 12, wherein a user does not hold the smartphone/tablet when the picture is taken.

17. A system for wirelessly controlling a camera, comprising:
a camera control device including a display and a transceiver; and
an electronic device including a camera module and a transceiver,
wherein when an image viewed by the electronic device is shown on the display of the camera control device, the camera control device is configured to control the electronic device to take a picture of the image.

18. The system of claim 17, wherein the electronic device is wirelessly controlled by the camera control device.

19. The system of claim 17, wherein a user does not hold the electronic device when the picture is taken.
